(19) United States
(12) Patent Application Publication
(10) Pub. No.: US 2011/0094184 A1
(43) Pub. Date: Apr. 28, 2011

(54) Systems and methods to display smoke propagation in multiple floors

(75) Inventors: Ji Gu, Shanghai (CN); Yusi Liu, Shanghai (CN); Thomas A. Plocher, Hugo, MN (US)

(73) Assignee: Honeywell International Inc., Morristown, NJ (US)

(21) Appl. No.: 12/589,735

(22) Filed: Oct. 28, 2009

(51) Int. Cl. E04B 1/94; G08B 17/10

(52) U.S. Cl. 52/741.3; 340/628

(57) ABSTRACT

A method of displaying smoke propagation in a region minimizes distractions due to building structural elements so that a user can focus on the smoke flow. An associated apparatus includes a plurality of smoke detectors and a display device which respond to smoke in the building. The apparatus generates the displays indicating the path of propagation of the developing smoke between floors. The display device can be wirelessly coupled to the apparatus.

### FIELD

The invention pertains to systems and methods to develop and present displays of the spread of smoke in multiple floor environments. More particularly, the invention pertains to such systems and methods which are directed to three dimensional building models.

### BACKGROUND

Structural fires cost the US economy more than $100 billion annually in property damage, fire department maintenance, and insurance premiums. Approximately 80 percent of fire deaths occur in homes. Trying to put out these fires costs 80 to 100 fire fighters their lives and 80,000 to 90,000 more are injured every year. Smoke and toxic gas inhalation cause the majority of fire fatalities. Flashover, occurs when flames erupt and rapidly fill a compartment. Despite fire codes and improved building designs, flashover and smoke spread are still major problems and require a more complete understanding of fire behavior.

Fire modeling and visualization tools can be used to overcome these problems, ultimately leading to the prevention of smoke and fire spread. The ability to visualize smoke and fire propagation in a 3D building model permits users to obtain the paths that smoke and fire is taking place. This ability generally provides the greatest benefits for the development of emergency procedures in emergency situations.

The visualization of smoke and fire propagation permits emergency planners to determine portions of structures that are generally more susceptible to fire and smoke damage, and to better develop evacuation routes that may be used in an emergency situation. In addition, the ability to visualize smoke and fire propagation may permit building managers to make informed decisions regarding the placement of certain infrastructure.

Currently, visualization of Smoke propagation in 3D building models may cause great cluttering and occlusion while complex building elements are visualized simultaneously with the smoke. Furthermore, if smoke propagates from a certain floor to its neighbor floor, the visualization may cause the user great troubles in identifying the smoke propagation path in each floor and prevent the indication of vertical propagation direction.

Moreover, since several consecutive floors are crowded with smoke, it may cause great trouble in indicating the association between smoke and floors. It would be even more difficult for users to identify a small area of interest when smoke propagates in.

Various prior art approaches are known. ANSYS Engineering Simulation Solution developed a fire and smoke propagation simulation system in atrium spaces. This system focuses on general trends of smoke propagation. Wire frame and semi-transparency are used as indicator of walls and floors of the building.

Daniel Madrzykowski, Glenn P. Formey and William D. Walton in Building and Fire Research Laboratory of National Institute of Standards and Technology created a system to evaluate a fire disaster occurred in a multi-floor building. This system utilizes mix rendering mode (solid and wireframe) to enable a clear visualization of smoke and fire propagating within two floors. (Daniel Madrzykowski, Glenn P. Formey, William D. Walton, Simulation of the Dynamics of a Fire in a Two-Story Duplex—Iowa, Dec. 22, 1999)

Glenn P. Formey introduced a smoke visualization tool named Smokeview. This system used solid meshes to visualize building elements. Users are able to switch rendering mode of smoke propagation among mesh plane, realistic particles and color coding vectors. The tool gives users ability to choose the layer of interest by their own and provides clear information of interest.

### BRIEF DESCRIPTION OF THE DRAWINGS

FIG. 1 illustrates a slide bar to alternate visualization strength in connection with one method in accordance with the invention;

FIG. 2 illustrates a slide bar to balance visualization strength in connection with the one method;

FIG. 3 illustrates a smoke propagation display with selected visual strength of smoke and building elements;

FIG. 4 illustrates smoke propagation with different visual strength of smoke and building elements;

FIG. 5 illustrates smoke propagation with yet another combination of visual strength of smoke and building elements;

FIG. 6 illustrates a single group of clipping planes in accordance with a second embodiment of the invention;

FIG. 7 illustrates multiple groups of clipping planes in multiple floors;

FIG. 8 illustrates multiple groups of clipping planes serving several regions of vertical propagation;

FIG. 9 illustrates application of a clipping plane group;

FIGS. 10A-10P illustrate adaptive switching of building elements;

FIGS. 11A-11G are exploded views illustrating automatic perspective changing;

FIG. 12 illustrates rising arrow indicators of vertical propagation;

FIG. 13 illustrates use of arrows with smoke-texture as indicators;

FIG. 14 illustrates use of growing and swirling arrows as indicators; and

FIG. 15 illustrates a system which embodies the invention.

### DETAILED DESCRIPTION

While embodiments of this invention can take many different forms, specific embodiments thereof are shown in the drawings and will be described herein in detail with the understanding that the present disclosure is to be considered as an exemplification of the principles of the invention, as well as the best mode of practicing same, and is not intended to limit the invention to the specific embodiment illustrated.

In one aspect of the invention, a user could efficiently get basic and accurate information as to smoke such as propagation path, height, density and approximate temperature. In another aspect of the invention, a user could locate a certain area or room of interest when smoke propagates to it. In this instance, the user is able to visualize smoke propagation with no compensation of other building elements. In yet another aspect of the invention, the user can maintain clarity of the building elements and spatial orientation when smoke propagates through multiple floors.

In another aspect of the invention, the user could be aware when smoke propagates vertically. The user could identify the specific location where smoke propagates vertically and get detailed information of vertical propagation such as propagation speed, density, and destination. Embodiments of the invention can incorporate one or more methods which enable users to observe smoke propagation within multiple floors in a three dimensional model of a building.

In one method, a slide bar can be used to alternate visualization focus. This method, in a disclosed embodiment incorporates three slide bars to alternate and balance the visualization focus of smoke and building elements. The user manually alternates the visual strength of smoke and building elements separately or consistently. When users want to check the information of smoke, they can turn up the visual strength of smoke and turn down the visual strength of building elements. When users want to locate smoke in certain area of the building model, they can turn up the visual strength of building elements.

Alternately, adaptive clipping planes can be used to eliminate unnecessary building elements. This method applies manually-operated clipping planes to let users eliminate relatively less important information. They are able to visualize the important information more easily and clearly. When users choose a location of interest, they can generate an initial point centered to setup the center of a group of 4 clipping planes. They can adjust the precise position of each clipping plane making sure that the view has eliminated enough elements to avoid cluttering and occlusion while keeping necessary information remains. Users can keep track of the horizontal propagation of smoke by adjusting clipping planes with it. In yet another aspect of the invention, when the system detects vertical propagation of smoke, it automatically generates an initial center and groups of clipping planes.

Another aspect of the invention incorporates adaptive switching of building elements between 2D and 3D. In this method, most building elements can be illustrated as landmarks or two dimensional floor plans in the three dimensional environment. When the smoke propagation reaches one area, the building elements in this area will rise up as three dimensional objects accordingly. When smoke stops propagating in this area, the building elements will switch from three dimensional objects to two dimensional floor plan or landmarks. When displaying as two dimensional floor plan or landmarks, building elements cause much less occlusion issues. By retaining the area in which smoke is not propagating in as a two dimensional floor plan or landmarks, users can get clear information of smoke propagation more easily while not losing the understanding of the whole building.

Another method incorporates an exploded view with perspective alternation and an indicator for vertical propagation of smoke. In this method an exploded view can be used not only to reduce occlusion and cluttering issues, but also to emphasize vertical propagation. An exploded view enlarges the distance of vertical propagation. Users can observe the vertical propagation more clearly and precisely. Furthermore, to maximally separate two floors the system can automatically adjust perspective of the camera. Using smaller perspective can remarkably reduce occlusion and enable the users to view smoke propagation in multiple floors. Several visual aids can be incorporated as indicators of vertical propagation to ensure the accuracy of visualization of vertical propagation. Arrows, icons or vectors can be used as indicators of vertical propagation catching users' attention and making the source and destination of vertical propagation more easily to locate.

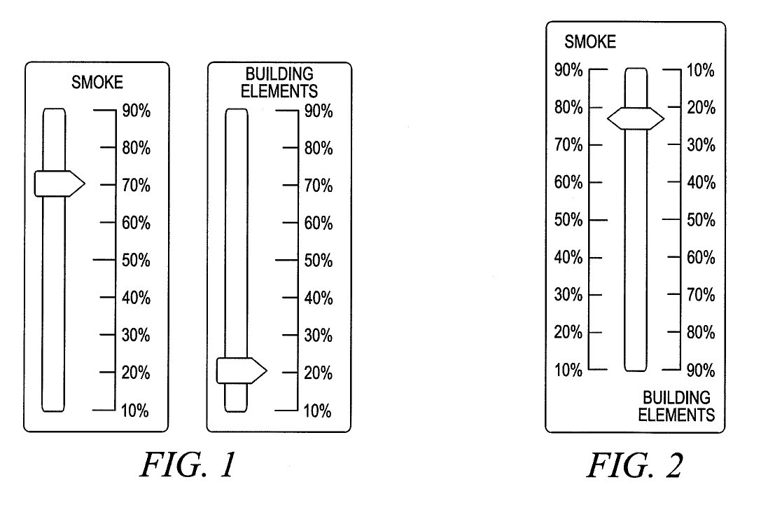

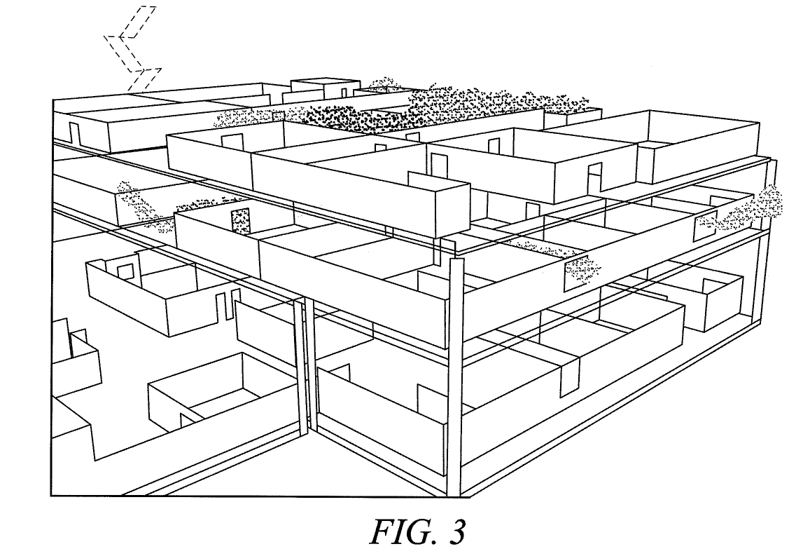

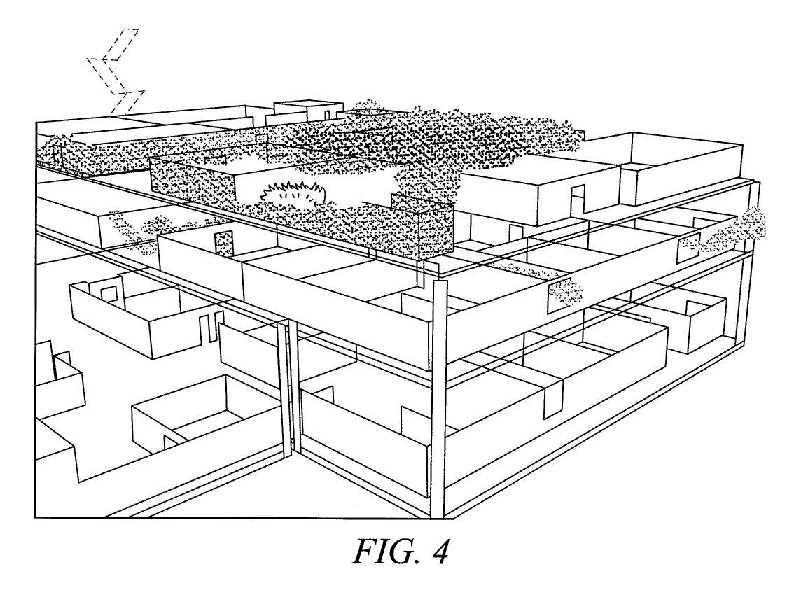

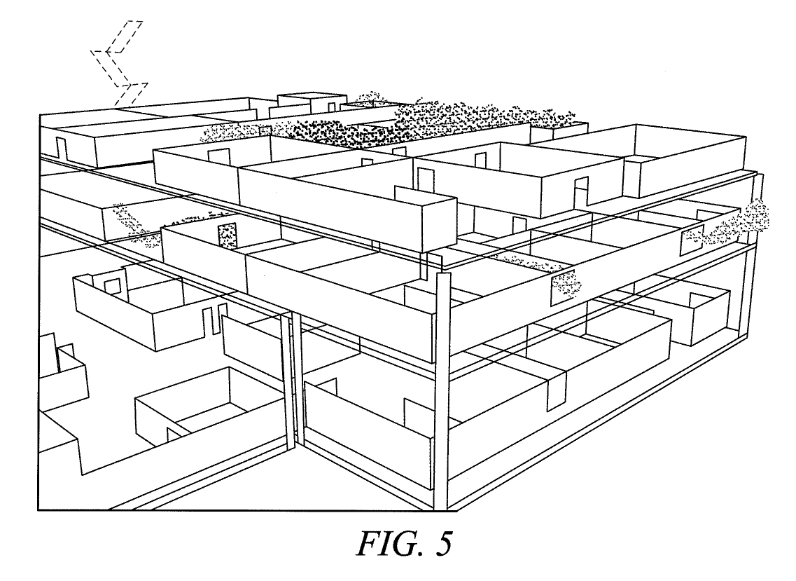

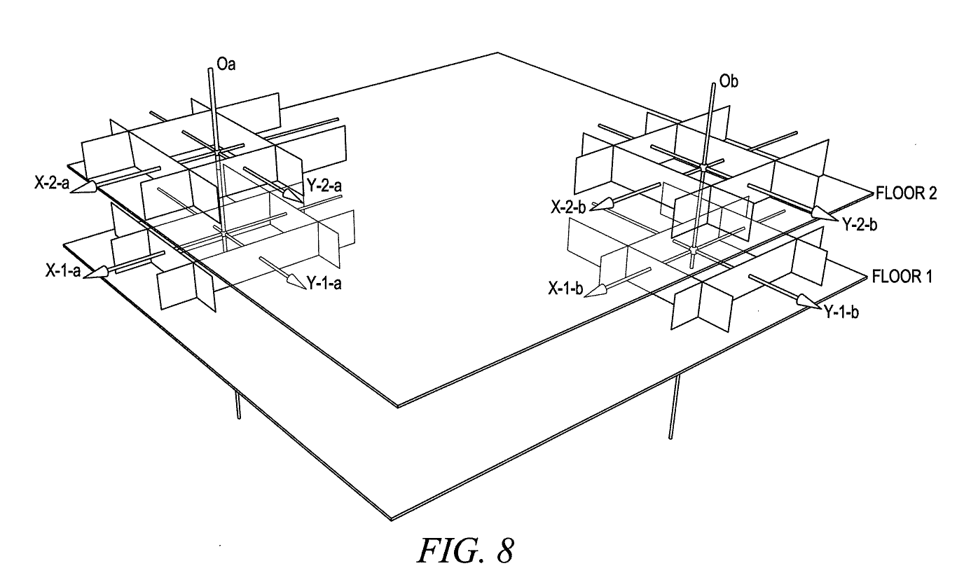

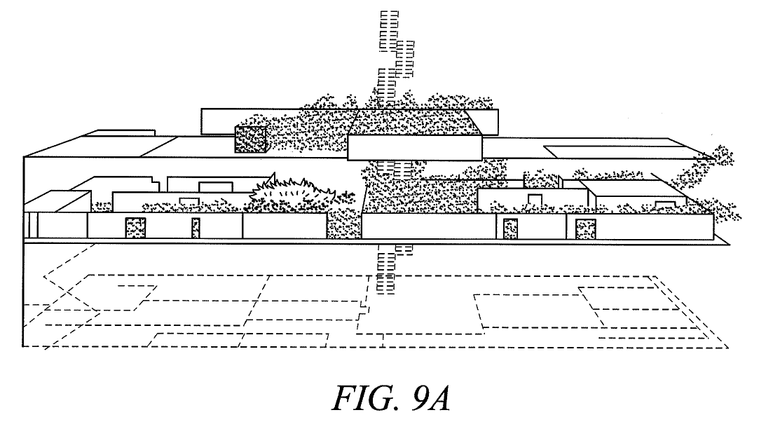

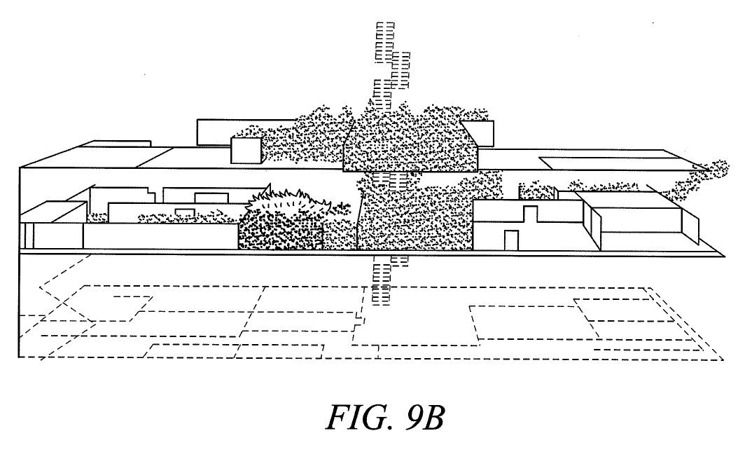

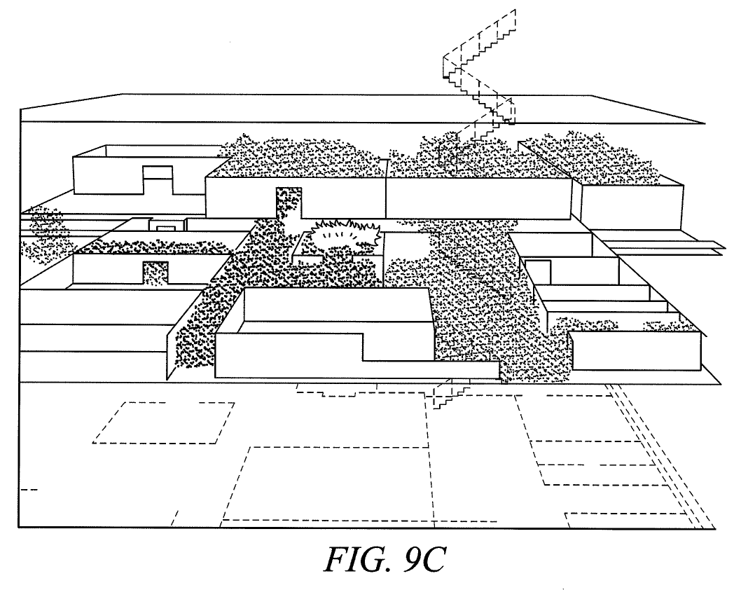

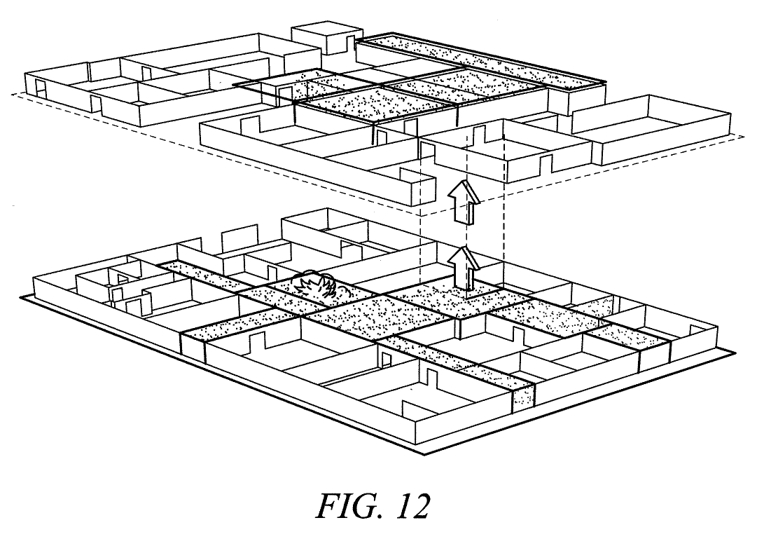

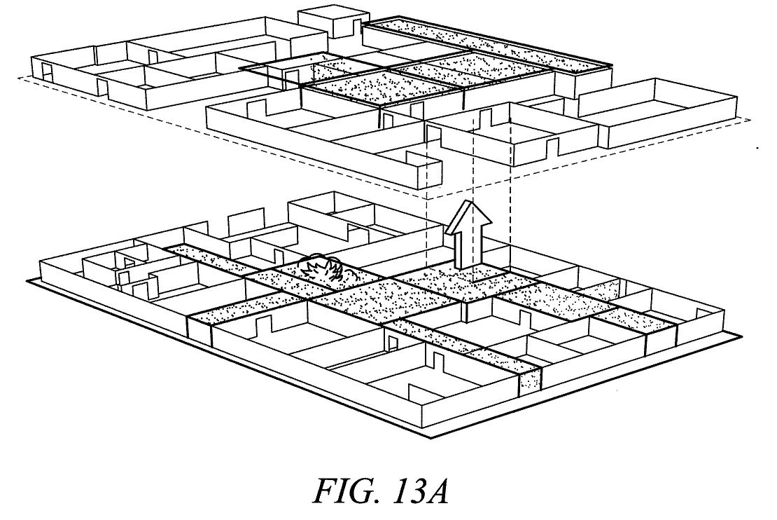

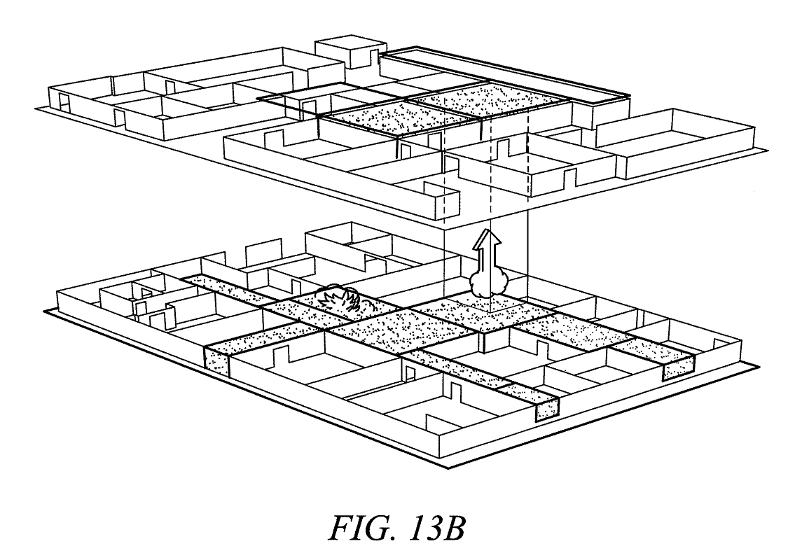

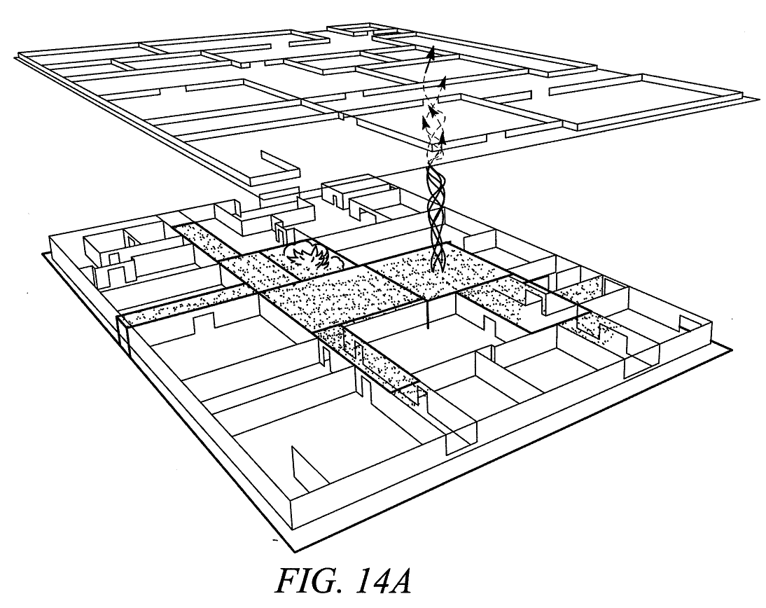

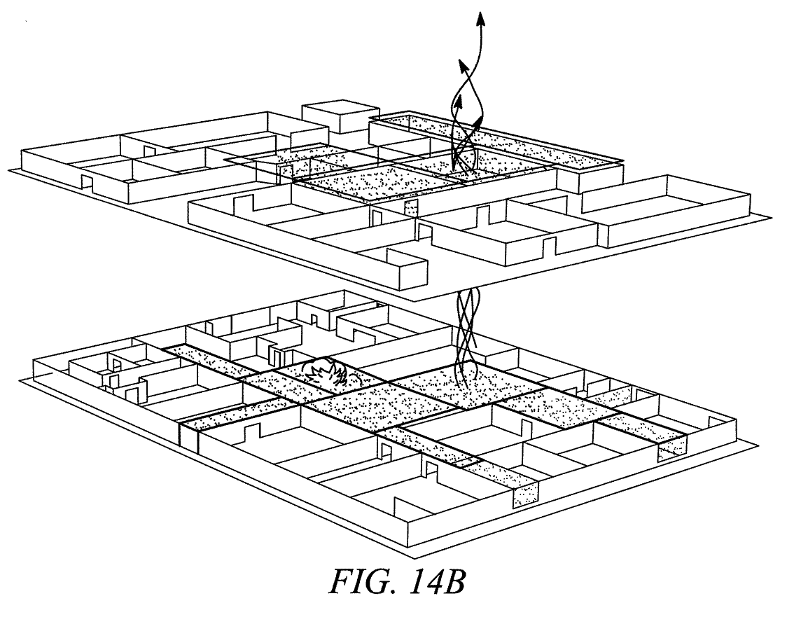

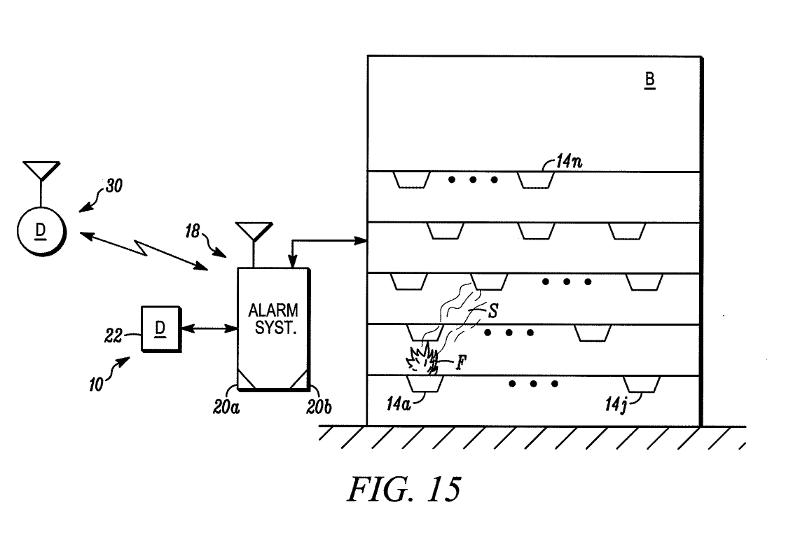

Various embodiments of the invention are described subsequently in combination with associated FIGS. 1-15. FIG. 15 illustrates a system 10 in accordance with the invention. For exemplary purposes, system 10 is illustrated installed, in part, to monitor an ambient condition, such as smoke, in a building B. A plurality of smoke detectors, such as 14a, 14b . . . 14j . . . 14n can be installed in the building B and coupled, wired or wirelessly to an alarm system monitoring unit 18.

Unit 18 can include one or more programmable processors 20a which execute software 20b stored on a computer readable medium, such as a disk drive or in a semiconductor memory unit. Unit 18 can also be coupled to a display unit D, illustrated generally at 22. As explained subsequently, in accordance with the invention, as the alarm system 18 is responding, via detectors 14i to a flow of smoke S from a fire F display 22 can present a dynamically changing set of images of progress of the smoke S from floor to floor in building B.

Advantageously, the system 18 can be in wireless communication, for example via a cellular-type provider or the internet with one or more displaced units, such as unit 30. Unit 30 which could be implemented as a wirelessly enabled personal computer or the like, with a display D1 could be located in one or more first responder vehicles. Hence, the fire chief, coming to the scene of a fire at building B could see even before arriving at the developing status of the fire F and associated smoke S.

Those of skill will understand that the following described processes could be implemented as software 20b executed in one or more of the processors 20a. Further, it will be understood that none of the specific hardware or software details of the units 18 and 30 are limitations of the invention, except as described herein.

Relative to FIGS. 1-5, a method 100 incorporates three slide bars, presented to the user on display 22 for example, to alternate and balance the visualization focus of smoke and building elements. The alteration and balance by the slide bar is used to manipulate visual strength of smoke and building elements in a single floor as well as the whole scene. The first slide bar is to alternate strength of smoke visualization. The second slide bar is to alternate strength of building elements. And the third slide bar is to alternate visual strength of both smoke and building elements visualization, and there is an opposite relation between smoke visualization and building elements visualization when using the third slide bar.

The parameters of smoke visualization are number of particles in certain space (Pn), life of particle in certain space (Pl), size of a single particle (Ps), opacity of particles (Po) and RGB color of map of particles (Pr, Pg, Pb). When the parameter value goes up, the strength of smoke visualization goes up. The formula is:

A (Value of the smoke strength slide bar)=f (Pl, Ps, Pn, Po, Pr, Pg, Pb)

When the smoke strength slide bar moves up, parameters of smoke visualization go up and the smoke visualization is getting stronger. At this moment, user could get relatively clear, precise and more realistic vision of smoke propagation and other information about smoke.

The parameters of building elements visualization are floor opacity (Fo), Wall opacity (Wo) and opacity of Other elements (Oo). When the parameters value goes up, the strength of building elements visualization goes up. Vice versa.

The formula is:

B (Value of the building elements slide bar)=f (Fo, Wo, Oo)

When the building elements slide bar moves up, parameters of the building elements visualization go up and the building elements visualization is getting stronger. At this moment, user could get a vision of the building and be clear about the three dimensional environment.

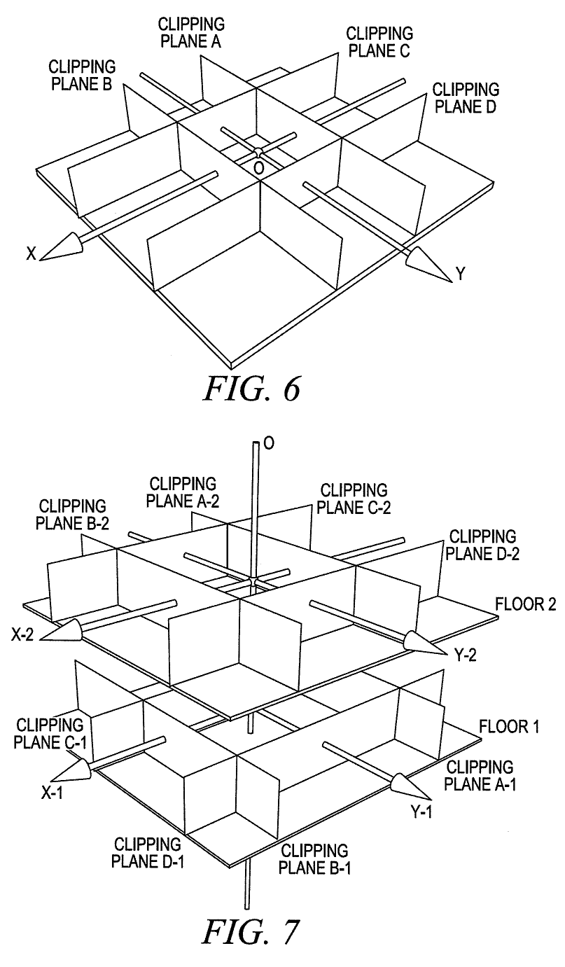

Relative to FIGS. 6-9 and a method 200, when smoke starts to propagate vertically, system automatically forms a coordinate based on the specific spot. The geometric centre of this spot will be defined as initial point. Users can also generate an initial center manually. And X axis and Y axis are formed with 90 degree angle crossing this initial point. Clipping plane A will be able to move from O to −X direction and visualization elements behind clipping plane A will be eliminated. Clipping plane B will be able to move from O to +X direction and visualization elements in front of clipping plane B will be eliminated. Clipping plane C will be able to move from O to −Y direction and visualization elements behind clipping plane C will be eliminated. Clipping plane D will be able to move from O to +Y direction and visualization elements in front of clipping plane D will be eliminated.

A user can move the clipping planes manually through the X axis and Y axis based on information on which direction they would like to eliminate. And the value of the movement is based on how much visualization information they want to eliminate to ensure visualization efficiency as well as occlusion reduction.

With multiple floors, users can use separate sets of clipping planes to cut away the floors individually. The initial point O becomes initial axis O, the axis X becomes axis X-1 and X-2, the axis Y becomes axis Y-1 and Y-2.

Multiple groups of clipping planes resist in a single floor as well as the same spot of multiple floors. When multiple vertical propagation occurs, there appears multiple groups of clipping planes. As one initial axis is Oa, another initial axis will be Ob, Oc and so on. Centered with initial axis Oa, there are axis X-1-a, X-2-a, Y-1-a and Y-2-a. It's the same with initial axis Ob, Oc and Od. Only the area inside the four clipping planes in the same group shows up while elements outside the clipping plane are eliminated.

Color-coding is used to differentiate different floors and groups of clipping planes.

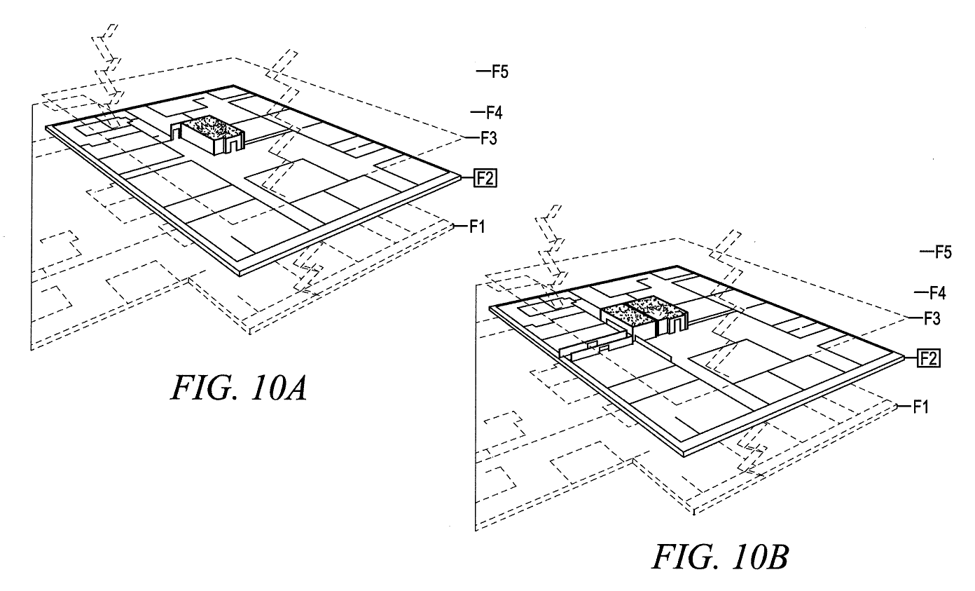

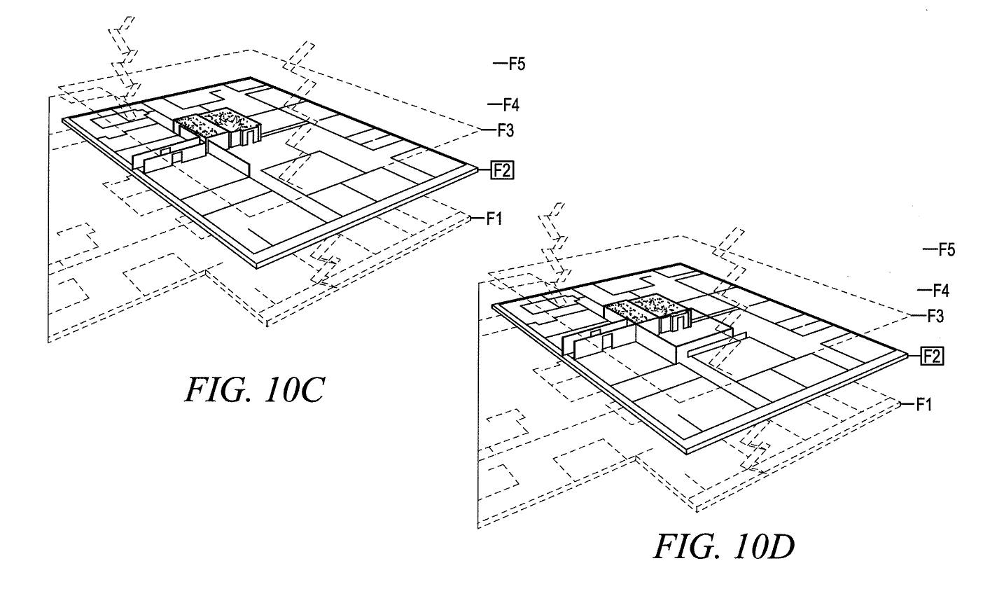

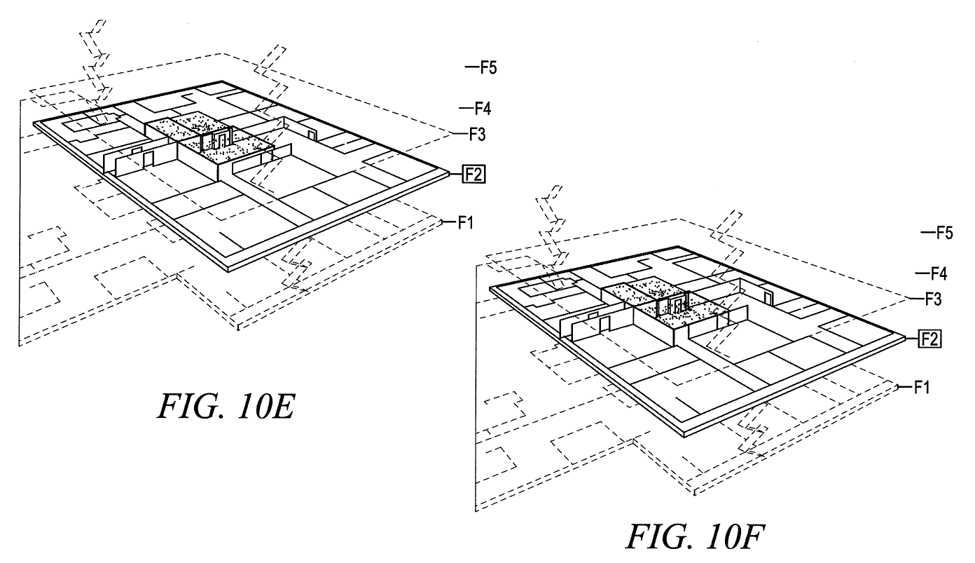

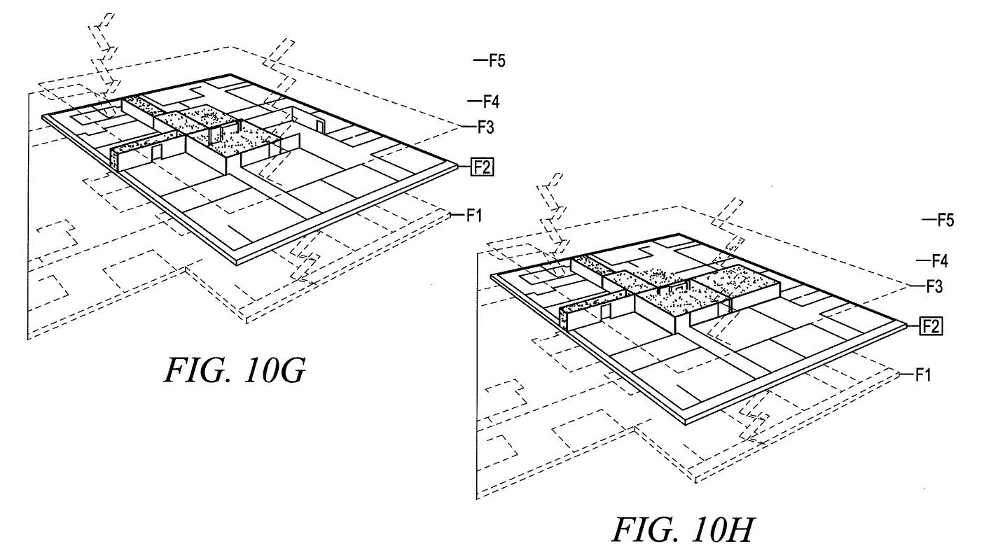

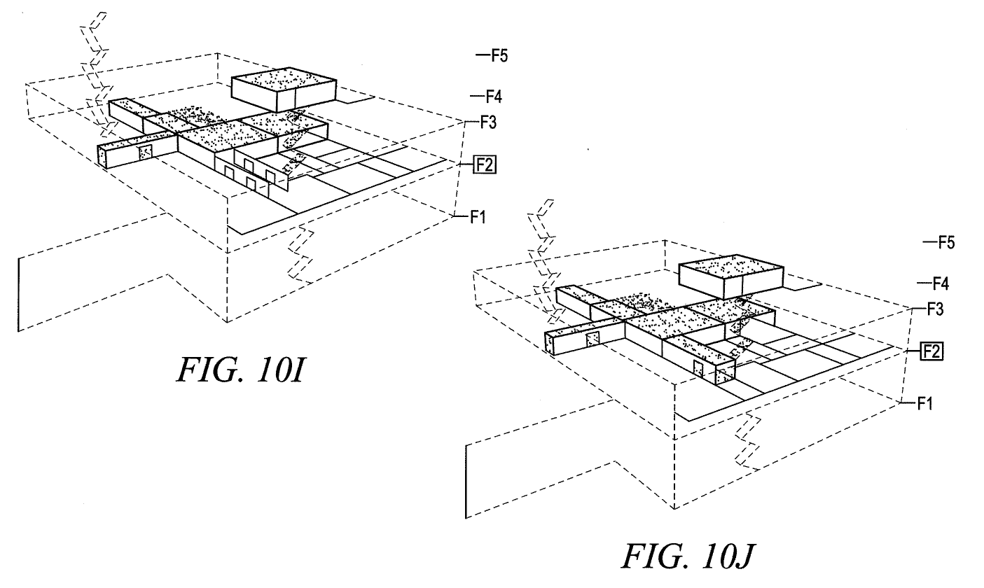

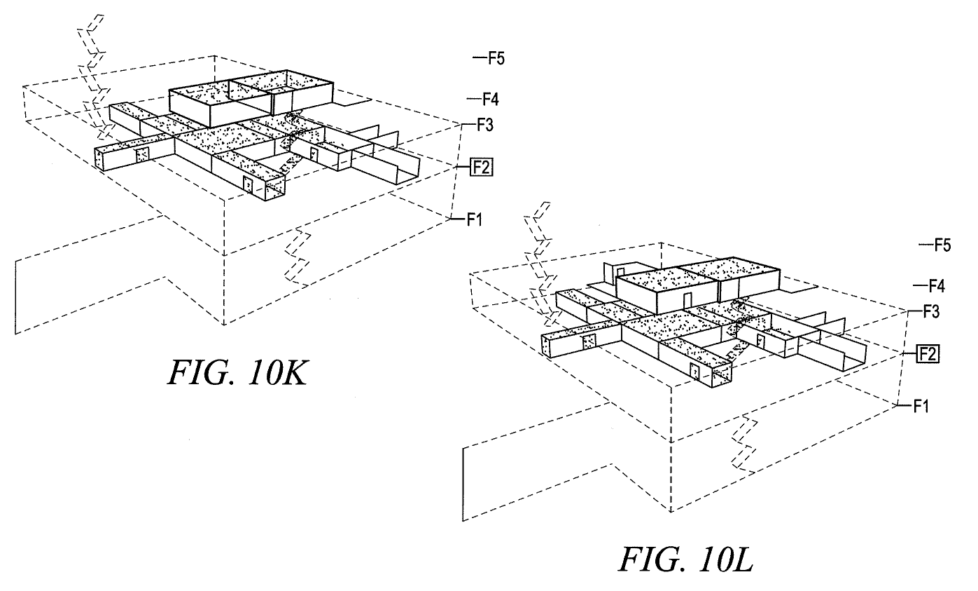

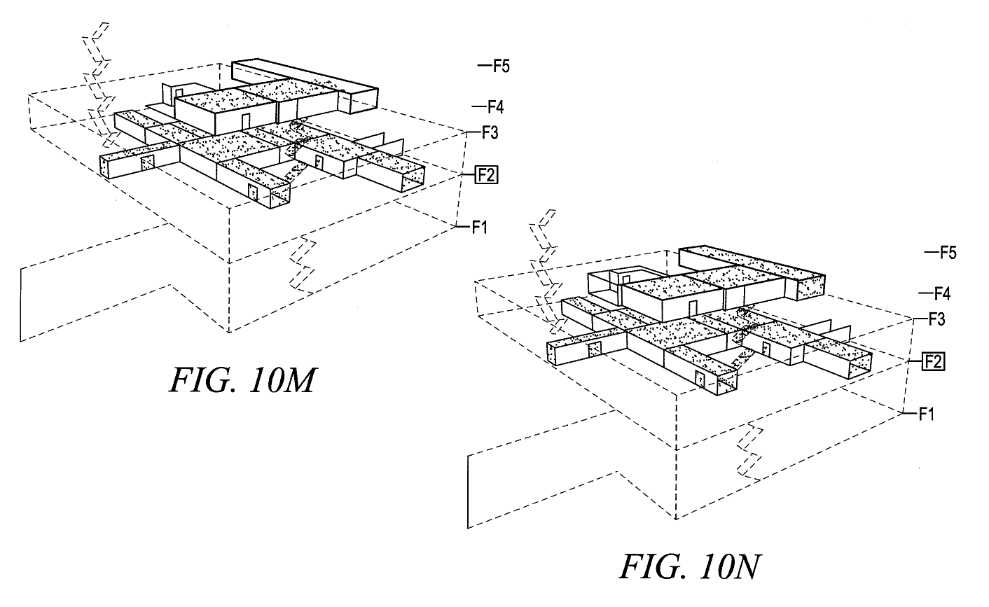

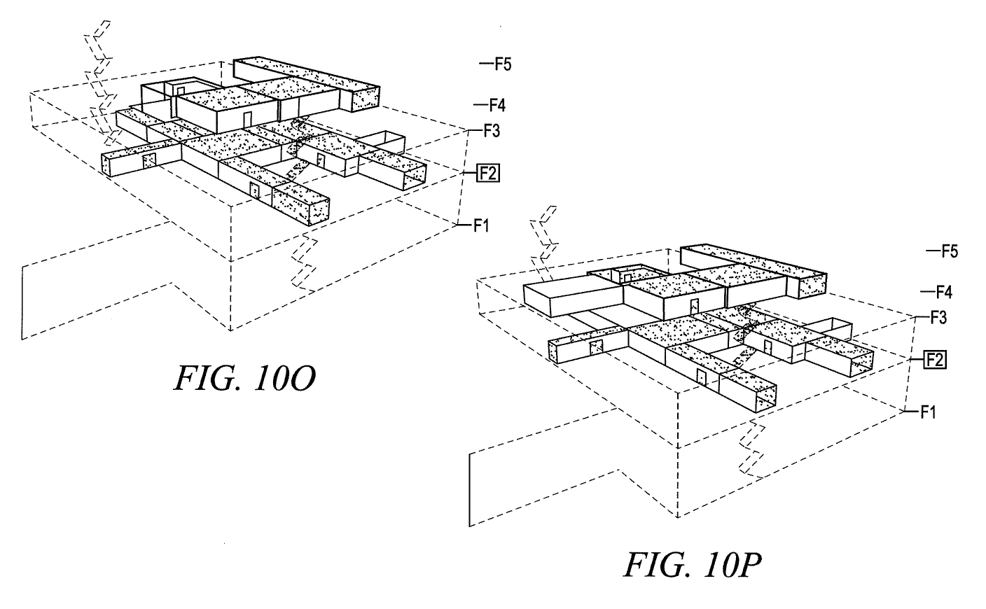

Relative to FIG. 10, two fidelity modes of building elements visualization apply in connection with a method 300. One is the low fidelity in which the building elements are simplified or even shown as two-dimensional floor plan. The other mode is the high fidelity in which the building elements are shown as three dimensional solid with details. These two modes transform into each other by scaling vertically in certain conditions. There is animation for the transformation that makes it look like the low fidelity mode rises up and forms up as the high fidelity mode so that users do not feel confused about the transformation.

The building model is divided into sub-areas, and each area has its elements. For two adjacent areas, there are elements that they share, such as walls or doors. Building elements are shown in low visual fidelity when no smoke propagation occurs. When smoke propagates near an area, the system detects the approach of the propagating smoke and building elements such as building walls and building pillars are automatically switched into high visual fidelity. And other places where no smoke propagates remain at low visual fidelity to avoid occlusion and cluttering.

Once the system detects that no smoke propagation is occurring in an area, building elements in this area will go down to low fidelity visualization mode.

Building elements in different floors are dynamically color-coded to avoid confusion.

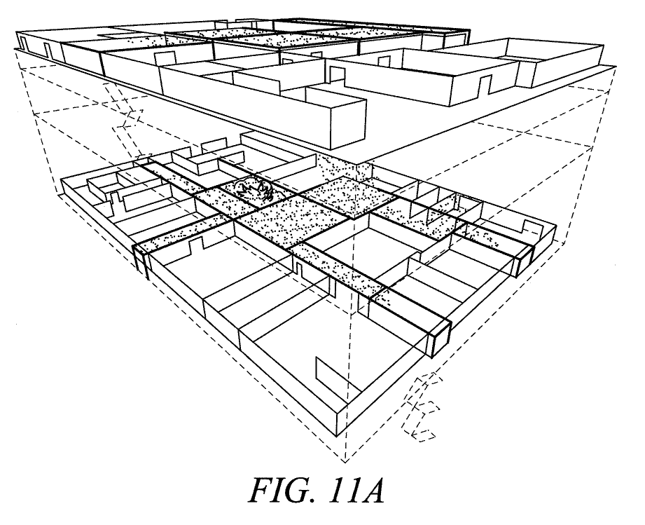

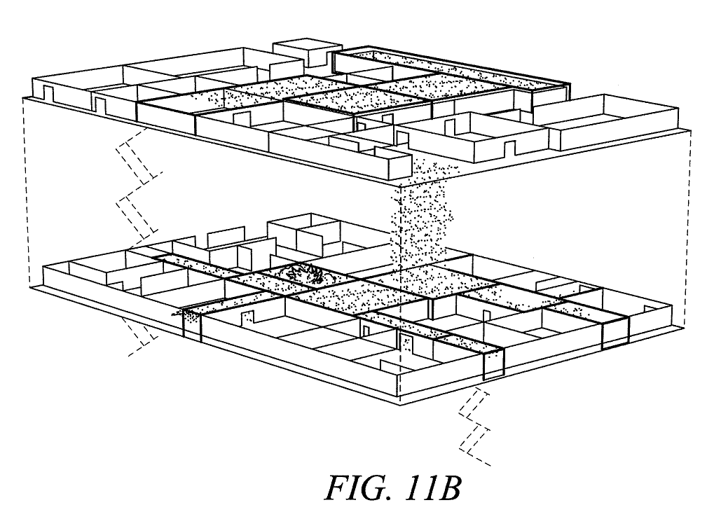

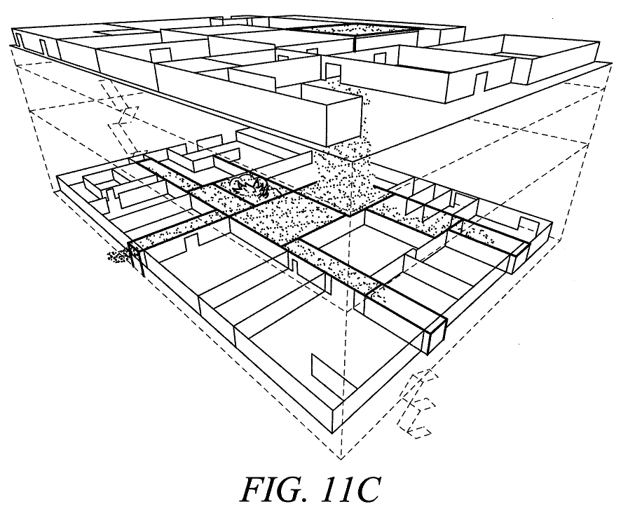

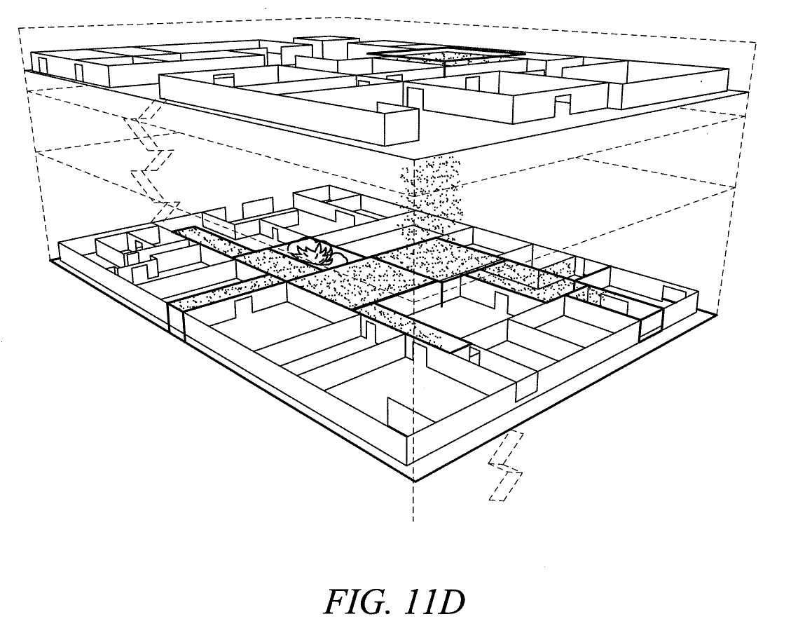

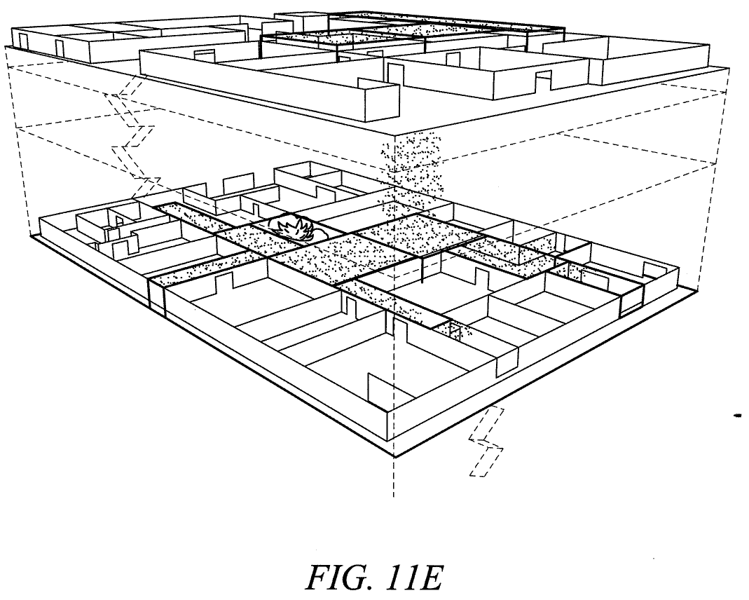

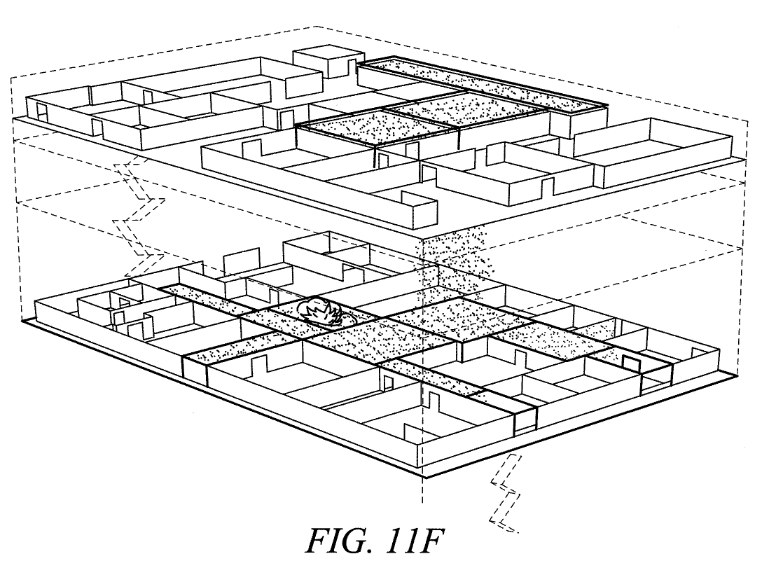

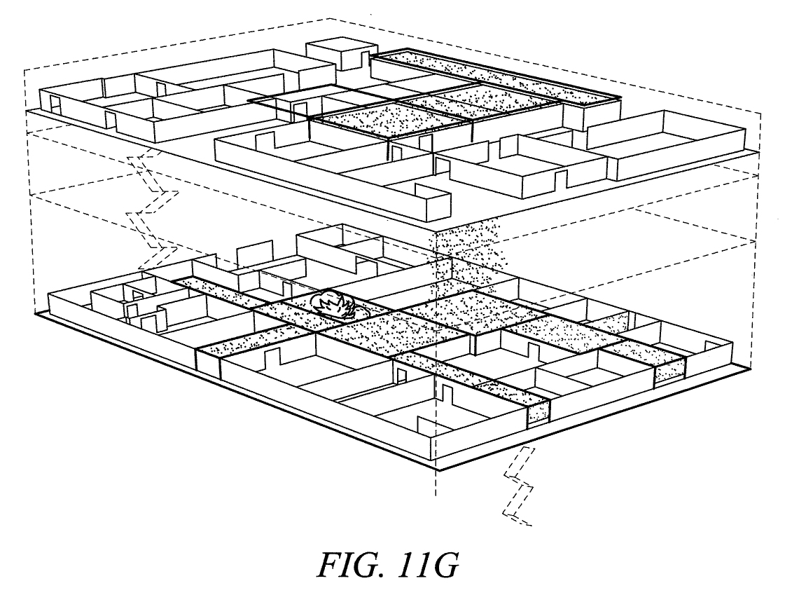

Relative to FIGS. 11-14, and a method 400, when smoke propagates in one floor, other floors remain semi-transparent. When system detects a vertical propagation and smoke starts to propagate to neighbor floors, the system automatically enlarges the distance of floors. The enlarged distance is determined by the total size of the floor plan. The formula is:

H=f(h,l,w)

H is the enlarged height of the exploded view (mm),

h is the original height between two floors (mm),

l is the length of the vertical propagation area (mm), and

w is the width of the vertical propagation area (mm).

There is a positive relation between H and h, l, w.

To further avoid occlusion caused by the building elements, the system automatically decreases the perspective of the shooting camera. This is done by moving the camera farther away from the building model while increasing the focal length and decreasing the shooting angle. The formula is:

P=f(FL,FOV,x,y,z)

P is the amount of perspective of camera,

FL is focal length of the camera (mm),

FOV is the field of view of the camera (degree), and

x, y, z are the three dimensional position of the camera (mm).

There is a negative relation between FL and P. When FL is getting larger, the perspective of the camera view is getting smaller. Meanwhile, the size of the visualized elements, including smoke and building, is getting smaller. So it is necessary to adjust FOV and x, y, z to maintain the size and position of the visualization elements and to ensure relatively spatial consistency.

As the distance of vertical propagation is increasing accordingly, to avoid ambiguity of vertical propagation, we add several visual aids as indicators of vertical propagation to ensure the accuracy of visualization of vertical propagation. The visual aids can be semi-transparent arrows, icons or growing vectors. These methods indicate the vertical propagation by catching attention of the users and visualizing the detailed information about where the vertical propagation stated and ended.

The visualization indicator of smoke vertical propagation can be semi-transparent arrows that constantly moving upwards.

The visualization indicator of smoke vertical propagation can be 3D objects that mapped with smoke-like texture or 2D icons with smoke texture.

Growing and swirling vector-arrows can vividly mimic the vertical propagation of smoke and show more detailed information about how strong the vertical propagation occur.

From the foregoing, it will be observed that numerous variations and modifications may be effected without departing from the spirit and scope of the invention. It is to be understood that no limitation with respect to the specific apparatus illustrated herein is intended or should be inferred. It is, of course, intended to cover by the appended claims all such modifications as fall within the scope of the claims.

1. A method comprising:
sensing a smoke condition in a predetermined, multi-floor region;
establishing the presence of a developing fire condition;
dynamically responding to sensed smoke conditions in the region to present, on at least one selected display unit a multi-floor representation of the sensed smoke condition by at least one of, providing display altering slide bars to alternate and balance visual focus of smoke and building elements, adaptively clipping planes to eliminate unnecessary, occluding building elements, adaptive switching of building elements between two dimensional and three dimensional representations, or, providing an exploded view with perspective alteration and an indicator of direction of smoke propagation.

2. A method as in claim 1 further including a first and second slide bars to independently adjust smoke and building element visual strength.

3. A method as in claim 2 which further includes a third slide bar to balance visualization strength of smoke and building elements.

4. A method as in claim 1 which includes displaying at least two different, adjacent floors of the region and independently adjusting the smoke and building element visual strength therein.

5. A method as in claim 4 which includes sensing the smoke at one location, creating the representation of the sensed smoke condition and transmitting that representation to a displaced display unit.

6. A method as in claim 1 that includes creating a set of clipping planes centered on the location of sensing the smoke condition.

7. A method as in claim 1 which includes manually adjusting at least one of the clipping planes.

8. A method as in claim 7 which includes responding to horizontal propagation of smoke by adjusting the clipping planes.

9. A method as in claim 1 where adaptive switching includes generating a display of some building elements in a two dimensional format in the absence of smoke in the associated area, and, responsive to smoke propagation into the area, converting the building elements from two dimensional representations into three dimensional representations.

10. A method as in claim 9 where a two dimensional representation is gradually and visually transitioned into a three dimensional representation maintaining user spatial orientation.

11. A method as in claim 9 which includes, when smoke ceases propagating into the area, converting at least some of the three dimensional representations back into two dimensional representations.

12. A method as in claim 1 where providing an exploded view includes providing perspective alteration of the image of the region.

13. A method as in claim 12 which includes providing an indicator of propagation of smoke between floors of the region.

14. A method as in claim 13 where providing an indicator includes providing at least one of arrows, icons or vectors as indicators of vertical propagation between floors.

15. An apparatus comprising:
a plurality of smoke detectors;
control circuitry coupled to the detectors to respond to electrical signals indicative of the presence of smoke in the vicinity of at least some of the detectors; and
circuitry to dynamically respond to sensed smoke conditions to present, on at least one selected display unit, a multi-floor representation of the sensed smoke condition by at least one of, providing display altering slide bars to alternate and balance visual focus of smoke and building elements, adaptively clipping plans to eliminate unnecessary building elements, adaptive switching of building elements between two dimensional and three dimensional representations, or, providing an exploded view with perspective alteration and an indicator of direction of smoke propagation.

16. An apparatus as in claim 15 where the display unit is wirelessly coupled to the circuitry.

17. An apparatus as in claim 15 where the control circuitry establishes an alarm condition, in response to the electrical signals, and produces audio and visual alarm indicating indicia in response thereto.
